(19) United States
(12) Patent Application Publication
(10) Pub. No.: US 2009/0037214 A1
(43) Pub. Date: Feb. 5, 2009

(54) METHOD OF BUILDING AN INTERNAL DIGITAL LIBRARY OF ABSTRACTS AND PAPERS

(75) Inventors: James V. Leonard, St. Charles, MO (US); William J. Ebert, Kirkwood, MO (US); Richard E. Meyer, Florissant, MO (US)

Correspondence Address: HUGH P. GORTLER, 23 Arrivo Drive, Mission Viejo, CA, 92692, US

(73) Assignee: THE BOEING COMPANY, Seal Beach, CA (US)

(21) Appl. No.: 12/253,194

(22) Filed: Oct. 16, 2008

Related U.S. Application Data
(63) Continuation-in-part of application No. 10/722,073, filed on Nov. 25, 2003.

(51) Int. Cl. G06Q 10/00; G06F 17/30; G06Q 50/00

(52) U.S. Cl. 705/1; 707/102; 707/E17.008; 707/E17.044

(57) ABSTRACT

Building an internal digital library for an organization includes accepting abstracts from members of the organization, the abstracts submitted for publication; performing internal review on the abstracts to approve or deny publication; storing approved abstracts in the internal digital library; and accepting papers corresponding to the abstracts and storing the papers in the internal digital library. The papers are stored regardless of whether they are approved for publication. Building the internal library further includes linking the abstracts to the corresponding papers; and making the abstracts accessible to members of the organization. A paper can be accessed from the internal library by following the link from its corresponding abstract.

### BACKGROUND

The present invention relates to digital libraries. More specifically, the present invention relates to a method of building an internal digital library for a corporation or other organization.

Large industrial manufacturers foster technical affiliations with engineering societies, universities, governments, and the rest of industry. These technical affiliations encourage intellectual cross-pollination. In fields such as aerospace and electronics, industry leaders seek to obtain and provide guidance in setting standards for interfaces, communications linking, and hardware, to name a few areas where technical affiliations can pay big dividends.

One such technical affiliation is through the submission of papers to engineering societies. To promote uniformity within the manufacturer and across the industry, industrial manufacturers have supported the submission of papers describing good engineering solutions to engineering societies.

The Institute of Electrical and Electronics Engineers, Inc. (IEEE) is a non-profit, technical professional association of more than 380,000 individual members in 150 countries. Through its members, the IEEE is a leading authority in technical areas ranging from computer engineering, biomedical technology and telecommunications, to electric power, aerospace and consumer electronics, among others. Through its technical publishing, conferences and consensus-based standards activities, the IEEE produces 30 percent of the world's published literature in electrical engineering, computers and control technology, holds annually more than 300 major conferences, and has nearly 900 active standards with 700 under development.

The IEEE keeps and indexes all of the papers and other submissions of its members for the purpose of enhancing the practice by the industry. With many of the societies, but with IEEE in particular, the whole of the indexed submissions are readily accessible by means of an active service page on the Internet. The industrial employer may download the submissions into an internal library kept for use by engineer employees.

Engineer employees of industrial manufacturers are often presenters at major conferences and contributors to the standards writing process through the IEEE. In many instances, the papers that engineer employees contribute may not be well-circulated even within the ranks of their co-workers. An unintended consequence is that the industrial manufacturer may pay several engineers to invent work on the same problem in different programs.

### SUMMARY

According to an embodiment herein, a method comprises building an internal digital library for an organization, including accepting abstracts from members of the organization, the abstracts submitted for publication; performing internal review on the abstracts to approve or deny publication; storing approved abstracts in the internal digital library; and accepting papers corresponding to the abstracts and storing the papers in the internal digital library. The papers are stored regardless of whether they are approved for publication. The method further comprises linking the abstracts to the corresponding papers; and making the abstracts accessible to members of the organization. A paper can be accessed from the internal library by following the link from its corresponding abstract.

### BRIEF DESCRIPTION OF THE DRAWINGS

FIG. 1 is an illustration of a method of building an internal digital library for an organization.

FIG. 2 is an illustration of a system for building and accessing the internal library.

FIG. 3 is a flowchart of a method of building an internal digital library for a corporation.

FIG. 4 is a flowchart of a method of augmenting the corporate library.

### DETAILED DESCRIPTION

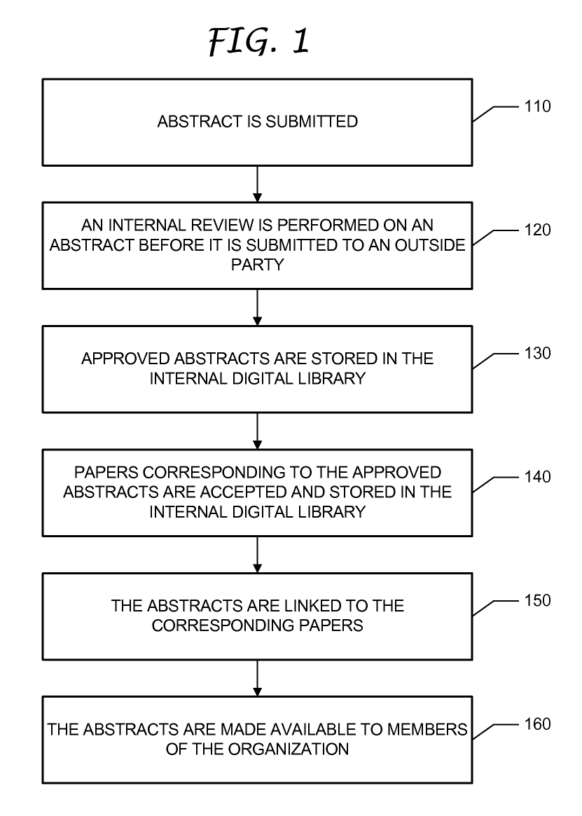

Reference is made to FIG. 1, which illustrates a method of building an internal digital library for an organization. At block 110, an abstract is submitted by one or more members of the organization. The abstracts are submitted with the intent of publication by an outside party, such as a technical society.

At block 120, an internal review is performed on an abstract before it is submitted to an outside party. The organization may perform the internal review to approve or deny publication.

At block 130, approved abstracts are stored in the internal digital library. At block 140 papers corresponding to the approved abstracts are accepted and stored in the internal digital library. The papers are stored regardless of whether they are approved for publication. Even if a paper undergoes internal review and is declined for publication, that paper can still be added to the internal library.

At block 150, the abstracts are linked to the corresponding papers. For example, the abstracts may be linked by placing hyperlinks in the abstracts.

At block 160, the abstracts are made available to members of the organization. As examples, the abstracts may be made accessible via a search engine or an internal website, or both. A paper can be accessed from the internal library by accessing the abstract and following the link to the paper.

The internal digital library can be expanded by repeating the functions at blocks 110-160.

The method produces an internal library having better organization of papers, better accessibility of papers, a wider range of available documents, and more efficient searching. The method has great utility for a large corporation whose employees submit large numbers of technical papers to different technical societies.

The internal library can provide a repository of papers prepared but not submitted for publication. Not all papers will be accessible from a technical society. For example, papers denied publication will not be accessible from the web site of a technical society. However, those papers will be accessible from the internal library. Thus, the method allows a broader range of documents to be accessed by members of the corporation.

As another advantage, it reduces the instances where employees submit duplicate papers, since employees can access the internal library to determine whether they are duplicating the efforts of their co-workers. As a benefit, corporate resources are preserved.

The method allows the organization to make all published papers accessible to its members, rather than relying on a technical society to make them accessible. Thus, instead of visiting a technical society's website, the member can visit the organization's internal website.

Members of the corporation might submit papers to many different organizations. The method allows all papers to be accessed from a single site, instead of multiple sites run by different technical societies.

Papers in the internal digital library are screened by the organization. Thus, papers in the library conform to standards set by the corporation, not by an outside organization.

Searching is more efficient. Papers stored in the internal library will be relevant to the large organization. Not all papers accessible from a technical society will be relevant to the corporation.

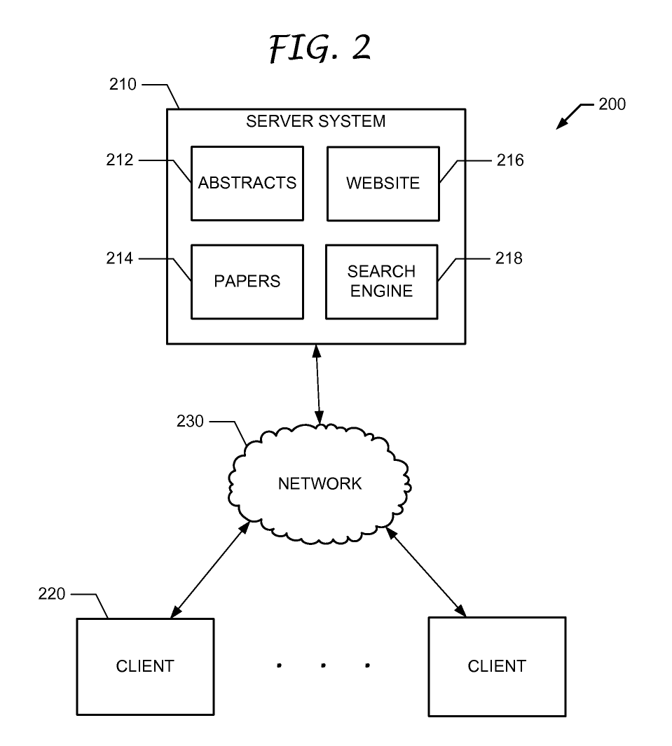

Reference is made to FIG. 2, which illustrates a system 200 for building and accessing the internal digital library. The system 200 includes a server system 210 for storing approved abstracts 212, and papers 214. The abstracts and papers may be stored in one or more databases. The server system 210 also includes means such as a website 216 and/or search engine 218 for making the abstracts accessible to members of the organization. The server system 210 may be controlled and operated by the organization.

The system 210 further includes a plurality of clients 220 for accessing the website 216, the search engine 218, or other means. The clients may communicate with the server via a network 230, such as a local area network or the Internet. The clients 220 may include computers, workstations, phones, and other machines capable of viewing the internal website 216 and running the search engine 218. For example, the clients 220 may run web browsers for accessing the internal website 216 and the search engine 218.

Members may submit their abstracts and papers via the clients 220. Those people responsible for performing the internal review can access the abstracts and papers via the clients 220. Those people responsible for adding the links to the abstracts may perform that task via the clients 220.

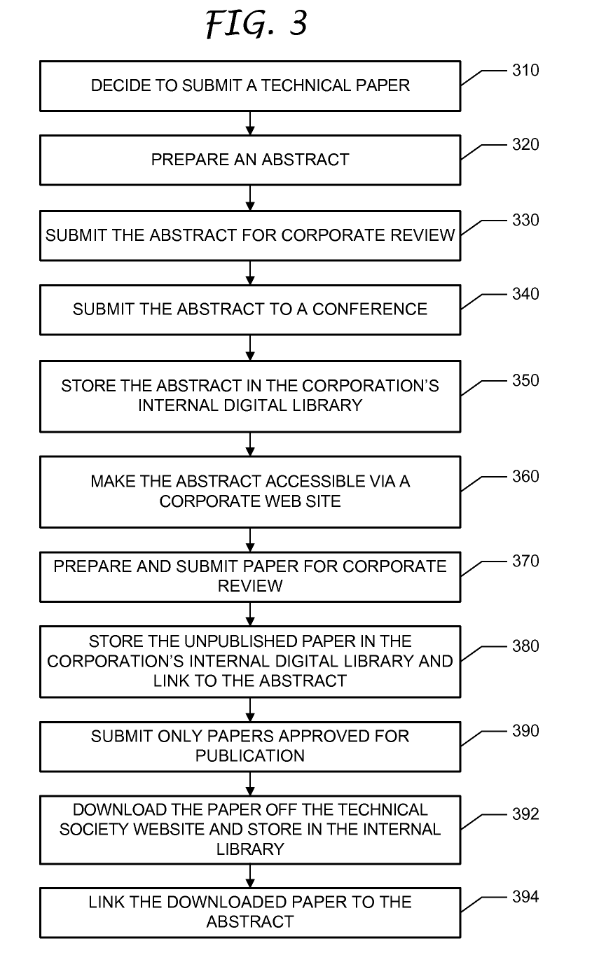

Reference is now made to FIG. 3, which illustrates a method of building an internal library for a large high-tech corporation. At block 310, an engineer employee decides to submit a technical paper. This decision might be prompted by a call for papers from a technical society. Such calls will allow the employee to attend a conference and a present a paper at the conference. These conferences typically present the most recent developments in the field of study affiliated with the technical society.

At block 320, if the employee decides to submit a technical paper and gets the necessary permission from the corporation, the employee prepares an abstract. An abstract is a regular means for societies to narrow the large number of submissions to those their membership will find interesting and appropriate. Abstracts allow societies to commit their resources to a reasonable number of authors without requiring each potential author to write the whole of a submission merely on the hope of publication.

At block 330, the employee submits the abstract for corporate review. The corporate review might involve aspects such as security, legal, export compliance, public relations, trade secrets, etc. The involvement of the corporation may, advantageously, include declining to submit for publication an abstract that includes trade secrets, etc.

At block 340, the employee submits the abstract to the conference. If the abstract is accepted, the technical society will publish it. Part of the acceptance includes a demand for the employee to prepare and submit a paper corresponding to the abstract.

At block 350, if the abstract is accepted, it is stored in the corporation's internal digital library. Generally, a librarian (or other responsible party) can obtain the abstract that was submitted for corporate review (at block 330). Instead, the abstract could be obtained directly from the employee, or from the website of the technical society publishing the abstract.

At block 360, information about the abstract (e.g., the paper title, the abstract itself, authorship, searchable terms, etc.) is placed on the corporate web site. This will allow other members of the corporation to find the abstract with a search engine.

At block 370, the employee prepares a paper and submits the paper for corporate review. At block 380, once the corporation approves the paper for publication, the approved unpublished paper is stored in the internal library. At this point, a hyperlink may be added to the corresponding abstract, thus linking the abstract and the paper.

At block 390, the approved paper is also submitted to the conference. Generally as a part of submission, the technical society edits and begins a dialogue to conform the paper to the needs of the technical society. When the paper is suitable, the technical society accepts it completing the submission and slates the paper for presentation at the conference according to the technical society's schedule for presentation.

Even if the technical society does not accept the paper, or modifies the paper, the original paper will still be stored in the corporation's internal library. Thus, the unpublished paper will be immediately accessible by other members of the corporation.

Eventually the employee presents the paper in accord with the ordinary procedure of the technical society. The technical society publishes the paper on its website, generally subsequent to the employee's oral presentation of the paper, though not necessarily so.

At block 392, after publication, the librarian may download the paper off of the technical society website and store it in the internal library. At block 394, the librarian embeds a hyperlink in the abstract, linking the abstract to the published paper and thereby making the published paper accessible by other members of the corporation. The abstract may have multiple links. For instance, the abstract may be linked to a published paper in the internal library, an unpublished paper in the internal library, and a published paper on the technical society's web site.

The hyperlink has other value. It can facilitate electronic processing. For instance, a link to the unpublished paper might make the unpublished paper easy to access for internal review.

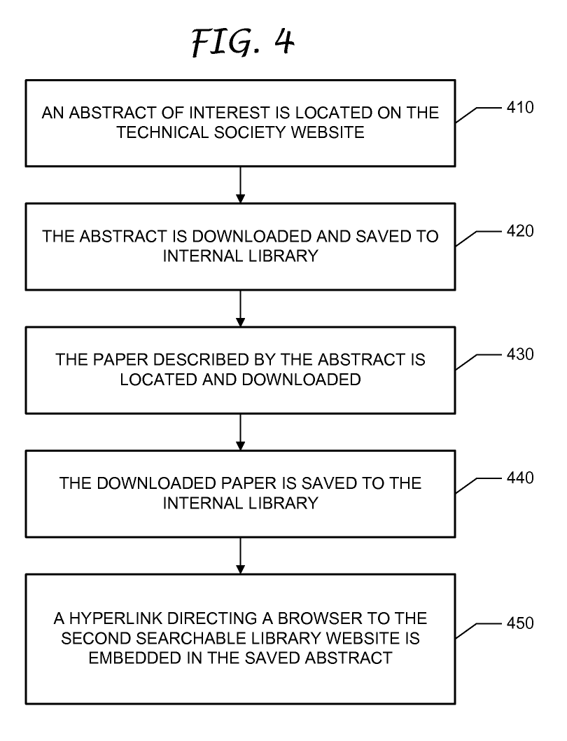

Reference is now made to FIG. 4, which illustrates a method of augmenting a library with a published paper. Published abstracts and papers are downloaded from web sites, linked, stored in the internal digital library, and made accessible to members of the organization. Where an abstract and a paper reside on a technical society website, the process of augmenting an employer's library can be accomplished by automated process.

At block 410, an abstract of interest is located on the technical society website. Such abstracts need not be recent so long as they describe papers available for download.

At block 420, upon locating an abstract of interest, the abstract is downloaded and saved to the internal library (e.g., a database).

At block 430, once the abstract of interest is located, the paper described by the abstract is located and downloaded. Generally, some indicia of the location of the paper will be found where the abstract is located in the form of a URL address or a hyperlink.

At a block 440, the downloaded a paper is saved to the internal library. At a block 450, a hyperlink to the downloaded paper is embedded in the stored abstract.

1. A method comprising building an internal digital library for an organization, comprising:
accepting abstracts from members of the organization, the abstracts submitted for publication;
performing internal review on the abstracts to approve or deny publication;
storing the approved abstracts in the internal digital library;
accepting papers corresponding to the approved abstracts and storing the papers in the internal digital library, regardless of whether the papers are approved for publication;
linking the abstracts to the corresponding papers; and
making the abstracts accessible to members of the organization;
wherein a paper can be accessed from the internal library by following the link from its corresponding abstract.

2. The method of claim 1, wherein the abstracts are made accessible via a search engine.

3. The method of claim 1, wherein the abstracts are made accessible via an internal web site.

4. The method of claim 1, wherein the abstracts are linked to the papers by placing hyperlinks in the abstracts.

5. The method of claim 1, further comprising storing a published paper corresponding to an abstract, and also linking the abstract to the published paper, whereby the abstract contains multiple links to the published and unpublished papers.

6. The method of claim 1, further comprising performing internal review on the papers to permit or deny publication.

7. The method of claim 1, further comprising downloading published abstracts and papers from web sites, linking them, and storing them in the internal digital library, and making the downloaded abstracts accessible to members of the organization.

8. A server system for building an internal digital library according to the method of claim 1.

10. A method comprising building an internal digital library for a corporation, comprising:
accepting abstracts from members of the corporation, the abstracts submitted for publication;
performing internal corporate review on the abstracts to approve or deny publication;
storing the approved abstracts in the internal digital library and making them accessible to members of the corporation;
accepting papers corresponding to the approved abstracts and storing the papers in the internal digital library;
linking the abstracts to the corresponding papers such that a paper can be accessed from the internal library by following the link from its corresponding abstract; and
performing internal corporate review of the papers to approve or deny publication;

11. The method of claim 10, further comprising linking at least some of the abstracts to published papers on web sites outside of the corporation
